(19) United States
(12) Patent Application Publication
(10) Pub. No.: US 2022/0080967 A1
(43) Pub. Date: Mar. 17, 2022

(54) VEHICLE CONTROL DEVICE, VEHICLE CONTROL METHOD, AND NON-TRANSITORY COMPUTER READABLE STORAGE MEDIUM

(71) Applicant: Honda Motor Co., Ltd., Tokyo (JP)

(72) Inventors: Etsuo WATANABE, Tokyo (JP); Ryoichi INOUE, Saitama (JP)

(73) Assignee: Honda Motor Co., Ltd., Tokyo (JP)

(21) Appl. No.: 17/460,277

(22) Filed: Aug. 29, 2021

(30) Foreign Application Priority Data
Sep. 15, 2020 (JP) 2020-154472

(51) Int. Cl. B60W 30/14; B60W 30/18; B60W 40/04; B60W 40/105; B60W 60/00

(52) U.S. Cl. CPC B60W 30/146; B60W 30/18163; B60W 40/04; B60W 2552/53; B60W 60/0015; B60W 2552/05; B60W 40/105

(57) ABSTRACT

A vehicle control device, a vehicle control method, and a non-transitory computer readable storage medium capable of increasing the traveling safety in the case where an overtaking vehicle approaches in the traveling control of the own vehicle are provided. A vehicle control device includes: a recognition part, recognizing an overtaking vehicle presumed to overtake an own vehicle from rear of the own vehicle in an own lane in which the own vehicle travels; and a driving control part, automatically controlling at least acceleration and deceleration of the own vehicle, and, in a case where the overtaking vehicle is recognized, determining a traveling velocity of the own vehicle based on a number of lanes of a road on which the own vehicle travels.

### CROSS-REFERENCE TO RELATED APPLICATION

This application claims the priority benefit of Japan application serial no. 2020-154472, filed on Sep. 15, 2020. The entirety of the above-mentioned patent application is hereby incorporated by reference herein and made a part of this specification.

### BACKGROUND

### Technical Field

The disclosure relates to a vehicle control device, a vehicle control method, and a non-transitory computer readable storage medium.

### Description of Related Art

In recent years, studies on automatic vehicle control have been progressing (see Patent Document 1).

### PRIOR ART DOCUMENT

### Patent Document

Patent Document 1: Japanese Patent No. 6264271.

In the conventional vehicle control method, in the case where a vehicle trying to overtake the own vehicle (hereinafter referred to as “overtaking vehicle”) approaches, it is possible that the traveling safety is not always sufficient.

### SUMMARY

A vehicle control device, a vehicle control method, and a non-transitory computer readable storage medium according to the disclosure adopt a configuration as follows.

A vehicle control device according to an aspect of the disclosure includes: a recognition part, recognizing an overtaking vehicle presumed to overtake an own vehicle from rear of the own vehicle in an own lane in which the own vehicle travels; and a driving control part, automatically controlling at least acceleration and deceleration of the own vehicle, and, in a case where the overtaking vehicle is recognized, determining a traveling velocity of the own vehicle based on a number of lanes or a road type of a road on which the own vehicle travels.

A vehicle control method according to an aspect of the disclosure includes: by a computer, recognizing an overtaking vehicle presumed to overtake an own vehicle from rear of the own vehicle in an own lane in which the own vehicle travels; and at a time when at least acceleration and deceleration of the own vehicle are under automatic control, in a case where the overtaking vehicle is recognized, determining a traveling velocity of the own vehicle based on a number of lanes of a road on which the own vehicle travels.

A non-transitory computer readable storage medium according to an aspect of the disclosure stores a program. The program causes a computer to: recognize an overtaking vehicle presumed to overtake an own vehicle from rear of the own vehicle in an own lane in which the own vehicle travels; and at a time when at least acceleration and deceleration of the own vehicle are under automatic control, in a case where the overtaking vehicle is recognized, determine a traveling velocity of the own vehicle based on a number of lanes of a road on which the own vehicle travels.

### BRIEF DESCRIPTION OF THE DRAWINGS

FIG. 1 is a diagram illustrating a configuration of a vehicle system using a vehicle control device according to a first embodiment.

FIG. 2 is a block diagram illustrating a specific example of the functional configurations of a first control part and a second control part in the first embodiment.

FIG. 3 is a flowchart illustrating a specific example of velocity adjustment of an own vehicle in the first embodiment.

FIG. 4 is a flowchart illustrating a specific example of a first velocity adjustment process in the first embodiment.

FIG. 5 is a diagram illustrating an example of the first velocity adjustment process in the first embodiment.

FIG. 6 is a flowchart illustrating a specific example of velocity adjustment of an own vehicle in a second embodiment.

FIG. 7 is a flowchart illustrating a specific example of a second velocity adjustment process in the second embodiment.

FIG. 8 is a diagram illustrating a specific example of the second velocity adjustment process in the second embodiment.

FIG. 9 is a flowchart illustrating a specific example of a second velocity adjustment process in a third embodiment.

FIG. 10 is a diagram illustrating a first example of the second velocity adjustment process in the third embodiment.

FIG. 11 is a diagram illustrating a second example of the second velocity adjustment process in the third embodiment.

FIG. 12 is a diagram illustrating a specific example of a hardware configuration of an automatic driving control device.

### DESCRIPTION OF THE EMBODIMENTS

The disclosure provides a vehicle control device, a vehicle control method, and a non-transitory computer readable storage medium capable of increasing the traveling safety in the case where the overtaking vehicle approaches in the traveling control of the own vehicle.

According to an embodiment of the disclosure, in a case where the overtaking vehicle is recognized and the own vehicle travels on a first type road having a single lane for a traveling direction, when the recognized overtaking vehicle performs lane changing from the own lane to an adjacent lane, the driving control part decelerates the own vehicle.

According to an embodiment of the disclosure, in a case where the overtaking vehicle is recognized and the own vehicle travels on a second type road having a plurality of lanes for a traveling direction, the driving control part does not decelerate the own vehicle in accordance with an operation of the overtaking vehicle and maintains the traveling velocity of the own vehicle at a set velocity.

According to an embodiment of the disclosure, in a case where the overtaking vehicle is recognized, the own vehicle travels on the second type road, and a side-by-side traveling state between the overtaking vehicle and the own vehicle continues for a predetermined time or more, or the overtaking vehicle and the own vehicle travel side-by-side for a predetermined distance or more, the driving control part decelerates the own vehicle.

According to an embodiment of the disclosure, in a case where the own vehicle travels on the second type road and stops side-by-side with the overtaking vehicle at a stop line, within a predetermined period after the own vehicle resumes traveling, the driving control part does not decelerate the own vehicle in accordance with the side-by-side traveling state.

According to an embodiment of the disclosure, in a case where the own vehicle travels on the second type road and travels in a region in which stop lines are consecutive at an interval of a predetermined distance or less, the driving control part does not decelerate the own vehicle in accordance with the side-by-side traveling state.

According to one or some embodiments of the disclosure, the vehicle control device recognizes the overtaking vehicle presumed to overtake the own vehicle from the rear of the own vehicle in the own lane in which the own vehicle travels, and, at the time when at least acceleration and deceleration of the own vehicle are under automatic control, in the case where the overtaking vehicle is recognized, determines the traveling velocity of the own vehicle based on the number of lanes of the road on which the own vehicle travels. Accordingly, in the vehicle control of the own vehicle, the traveling safety in the case where an overtaking vehicle approaches is increased.

According to one or some embodiments of the disclosure, in the case where the overtaking vehicle is recognized and the own vehicle travels on the first type road, when the recognized overtaking vehicle performs lane changing from the own lane to the adjacent lane, the vehicle control device decelerates the own vehicle, so the overtaking vehicle can quickly overtake the own vehicle.

According to one or some embodiments of the disclosure, in the case where the overtaking vehicle is recognized and the own vehicle travels on the second type road, the vehicle control device does not decelerate the own vehicle in accordance with the operation of the overtaking vehicle, but maintains the traveling velocity of the own vehicle at the set velocity. Accordingly, the traffic condition on the road can be prevented from worsening due to excessive deceleration, and the interference with the overtaking vehicle can be reduced.

According to one or some embodiments of the disclosure, in the case where the overtaking vehicle is recognized, the own vehicle travels on the second type road, and the side-by-side traveling state between the overtaking vehicle and the own vehicle continues for the predetermined time or more, or the overtaking vehicle and the own vehicle travel side-by-side for a predetermined distance or more, the vehicle control device decelerates the own vehicle. Accordingly, the overtaking vehicle can quickly overtake the own vehicle.

According to one or some embodiments of the disclosure, in the case where the own vehicle travels on the second type road and stops side-by-side with the overtaking vehicle at the stop line, within the predetermined period after the own vehicle resumes traveling, the driving control part does not decelerate the own vehicle in accordance with the side-by-side traveling state. Accordingly, in the case of traveling side-by-side with the overtaking vehicle, the own vehicle can quickly exit a low-velocity region in the vicinity of the stop line.

According to one or some embodiments of the disclosure, in the case where the own vehicle travels on the second type road and travels in the region in which stop lines are consecutive at the interval of the predetermined distance or less, the driving control part does not decelerate the own vehicle in accordance with the side-by-side traveling state. Accordingly, the own vehicle can quickly exit the low-velocity region even in the case of traveling side-by-side with the overtaking vehicle.

Hereinafter, the embodiments of a vehicle control device, a vehicle control method, and a program of the disclosure will be described with reference to the drawings.

### First Embodiment

### [Overall Configuration]

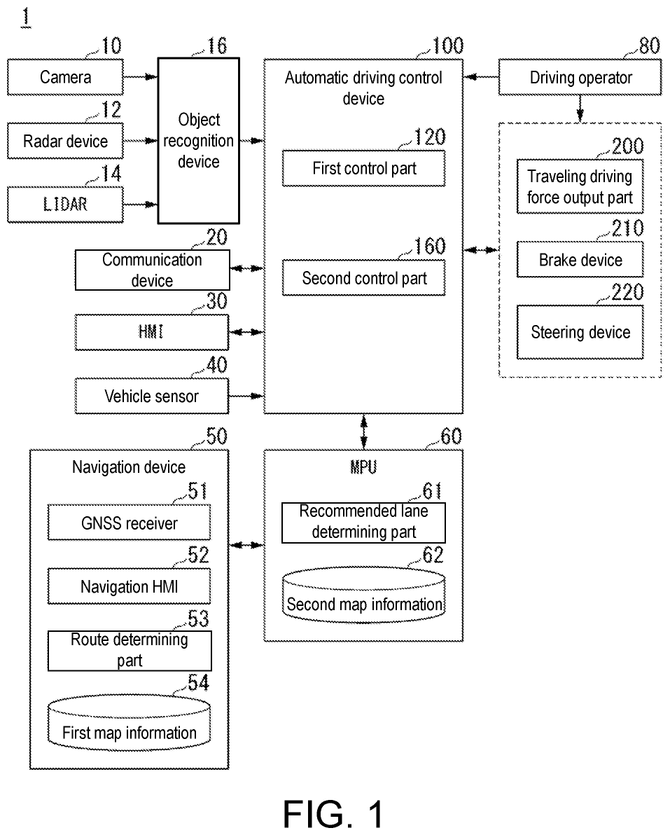

FIG. 1 is a diagram illustrating a configuration of a vehicle system 1 using a vehicle control device according to an embodiment. A vehicle where the vehicle system 1 is mounted is a two-wheel, three-wheel, four-wheel, etc., vehicle, for example, and the drive source thereof is an internal combustion mechanism such as a diesel engine, a gasoline engine, etc., an electric motor, or a combination thereof. The electric motor operates by using power generated by a power generator connected with the internal combustion mechanism or power discharged by a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automatic driving control device 100, a traveling driving force output device 200, a brake device 210, and a steering device 220. These devices or machines are connected with each other by multiple communication cables such as controller area network (CAN) communication cables, serial communication cables, a wireless communication network etc. It should be noted that the configuration shown in FIG. 1 merely serves as an example. A portion of the configuration may be omitted, and other configurations may also be further added.

The camera 10, for example, is a digital camera using a solid-state image capturing device such as a charge coupled device (CCD), a complementary metal oxide semiconductor (CMOS). The camera 10 may be attached to any place of the vehicle (own vehicle M in the following) where the vehicle system 1 is mounted. In the case of capturing an image of the front, the camera 10 is attached to the upper part of the front windshield or the inner side of a rearview mirror. The camera 10, for example, periodically and repetitively captures images of the periphery of the own vehicle M. The camera 10 may also be a stereo camera.

The radar device 12 radiates radio waves such as millimeter waves to the periphery of the own vehicle M and at least detects a position (distance and orientation) of an object by detecting radio waves (reflected waves) reflected by the object. The radar 12 may be attached to any place of the own vehicle M. The radar device 12 may also detect the position and the velocity of the object by using frequency modulated continuous wave (FW-CW).

The LIDAR 14 radiates light (or electromagnetic waves whose wavelengths are close to light) to the periphery of the own vehicle M and measures scattered light. The LIDAR 14 detects the distance to an object based on the time from light emission until light reception. The radiated light is, for example, pulse-like laser light. The LIDAR 14 may be attached to any place of the own vehicle M.

The object recognition device 16 performs a sensor fusion process according to some or all of the camera 10, the radar device 12, and the LIDAR 14 to recognize the position, the type, and the velocity of the object. The object recognition device 16 outputs the recognition result to the automatic driving control device 100. The object recognition device 16 may also output detection results of the camera 10, the radar 12, and the LIDAR 14 directly to the automatic driving control device 100. The vehicle system 1 may also omit the object recognition device 16.

The communication device 20 uses a cellular network, a Wi-Fi network, Bluetooth (registered trademark), dedicated short range communication (DSRC), etc., to communicate with other vehicles present around the periphery of the own vehicle M, or communicates with various server devices via a wireless base station.

The HMI 30 notifies the occupant of the own vehicle M with various information as well as receiving an input operation of the occupant. The HMI 30 includes various display devices, speakers, buzzers, touch panels, switches, keys and the like.

The vehicle sensor 40 includes a vehicle velocity sensor detecting the velocity of the own vehicle M, an acceleration sensor detecting acceleration, a yaw rate sensor detecting the angular velocity around the vertical axis, and an orientation sensor detecting the orientation of the own vehicle M, etc.

The navigation device 50 includes, for example, a global navigation satellite system (GNSS) receiver 51, a navigation HMI 52, and a route determining part 53. The navigation device 50 keeps a first map information 54 in a storage device such as a hard disk drive (HDD), a flash memory, etc. The GNSS receiver 51 specifies the position of the own vehicle M based on signals received from a GNSS satellite. The position of the own vehicle M may also be specified or complemented by an inertial navigation system (INS) using the output of the vehicle sensor 40. The navigation HMI 52 includes a display device, a speaker, a touch panel, a key, etc. The navigation HMI 52 may be partially or entirely shared with the HMI 30. The route determining part 53 refers to the first map information 54 to determine a route (referred to a route on the map in the following) from the position of the own vehicle M specified by the GNSS receiver 51 to the destination input by the occupant by using the navigation HMI 52. The first map information 54, for example, is information in which a road shape is expressed by a link indicating a road and nodes connected by the link. The first map information 54 may also include a road curvature or point of interest (POI) information, etc. The route on the map is output to the MPU 60. The navigation device 50 may also provide road guidance using the navigation HMI based on the route on the map. The navigation device 50, for example, may also be realized by the function of a terminal device such as a smart phone, a tablet terminal, etc., possessed by the occupant. The navigation device 50 may also transmit the current position and the destination to a navigation server via the communication device 20 and obtain a route equivalent to the route on the map from the navigation server.

The MPU 60, for example, a recommended lane determining part 61, and keeps a second map information 62 in a storage device such as a hard disk drive (HDD), a flash memory, etc. The recommended lane determining part 61 divides the route on the map provided by the navigation device 50 into multiple blocks (e.g., making a division every 100 m regarding the vehicle traveling direction), and refers to the second map information 62 to determine a recommended lane for each block. The recommended lane determining part 61 makes a determination regarding which lane from the left to travel. In the case where there is a branch point on the route on the map, the recommended lane determining part 61 determines the recommended lane so that the own vehicle M can travel on a reasonable route to proceed to the branch destination.

The second map information 62 is map information with a precision higher than the first map information 54. The second map information 62, for example, includes lane center information or lane boundary information etc. In addition, the second map information 62 may also include road information, traffic regulation information, address information (address, zip code), facility information, telephone number information etc. The second map information 62 may also be updated at any time through the communication of the communication device 20 with other devices.

In the following, when there is no special distinction, the first map information 54 and the second map information 62 are generally referred to as map information. In addition, the map information in the following may be one or both of the first map information 54 and the second map information 62.

In addition, in the embodiment, the navigation device 50 is an example of the means for obtaining map information relating to the road on which the own vehicle M travels. In the case where the automatic driving control device 100 has other means for obtaining map information, it is not necessary that the automatic driving control device 100 always includes the navigation device 50. For example, some or all of the map information may be obtained from a wireless communication apparatus of a road company, etc., provided near the road via the communication device, and may also be obtained from an external device via a cellular network, etc.

The driving operator 80, for example, includes an accelerator pedal, a brake pedal, a shift lever, a steering wheel, an odd-shaped steer, a joystick, other operators. A sensor detecting the operation amount and whether there is an operation is attached to the driving operator 80, and the detection result of the sensor is output to the automatic driving control device 100 or some or all of the traveling driving force output device 200, the brake device 210, and the steering device 220.

The automatic driving control device 100 includes, for example, a first control part 120 and a second control part 160. The first control part 120 and the second control part 160 are realized by executing a program (software) by a hardware processor such as a central processing unit (CPU). In addition, one or some of the forming components may also be realized by hardware (a circuit part, including a circuitry) such as a large scale integration (LSI) or an application specific integrated circuit (ASIC), a field-programmable gate array (FPGA), a graphics processing unit (GPU), and may also be realized through cooperation between software and hardware. The program may be stored in advance in a storage device (storage device including a non-transient storage medium) such as an HDD or a flash memory of the automatic driving control device 100, and may also be installed to the HDD or the flash memory of the automatic driving control device 100 by being stored in a detachable storage medium such as a DVD or a CD-ROM and attaching the storage medium (non-transient storage medium) to a drive device. The automatic driving control device 100 is an example of “vehicle control device”, and the action plane generation part 140 and the second control part 160 together is an example of “driving control part”.

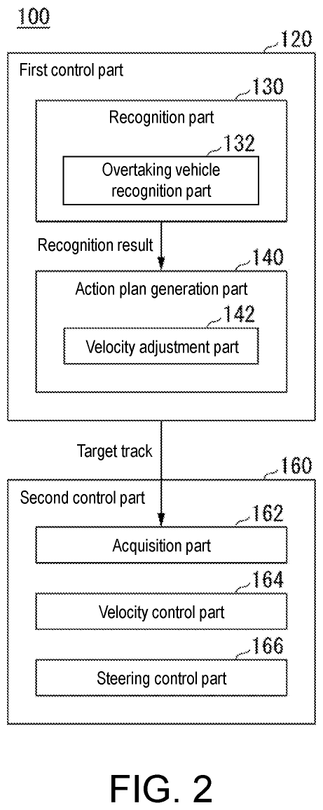

FIG. 2 is a block diagram illustrating a specific example of the functional configurations of the first control part 120 and the second control part 160. The first control part 120, for example, includes a recognition part 130 and an action plan generation part 140. The first control part 120, for example, realizes a function by artificial intelligence (AI) and a function by a model provided in advance in parallel. For example, the function of “recognizing an intersection” may be executed by performing recognition of an intersection by deep learning and recognition based on a predetermined condition (signal-matching signals, road markings, etc.) side-by-side, and may also be realized by rating both recognitions and giving a comprehensive evaluation. Accordingly, the reliability of the automatic driving is ensured.

The recognition part 130 recognizes the position, the velocity, and the acceleration of the object around the periphery of the own vehicle M based on the information input from the radar device 12 and the LIDAR 14 via the object recognition device 16. The position of the object, for example, is recognized at a position on absolute coordinates by setting a representative point (gravity center, drive shaft center, etc.) of the own vehicle M as the origin and is used for control. The position of the object may be represented as a representative point such as the gravity center or the corner of the object, and may also be represented in a represented region. The “state” of an object may include the acceleration or jerk of the object, or the “action state” (e.g., whether the vehicle is changing a lane or is about to change a lane).

In addition, the recognition part 130, for example, recognizes a lane (traveling lane) in which the own vehicle M travels. For example, the recognition part 130 recognizes the traveling lane by comparing the pattern (e.g., arrangement of solid and broken lines) of the road compartment lines obtained from the second map information 62 and the pattern of the road compartment lines in the periphery of the own vehicle M recognized from the image captured by the camera 10. The recognition part 130 may also recognize the traveling lane by recognizing a traveling boundary (road boundary) including a road compartment line, a road shoulder, a curb, a median, a guide rail, etc., without being limited to recognizing the road compartment line. In addition, the recognition part 130 recognizes the number of traveling lanes and the lane direction of the traveling lanes based on the second map information. The lane direction here does not mean that the vehicle can physically travel in the direction, but refers to the traveling direction of the vehicle determined as the traveling rules of the respective lanes based on road traffic-related regulations. The position of the own vehicle M obtained from the navigation device 50 and the processing result by INS may also be incorporated into such recognition. In addition, the recognition part 130 recognizes a stop line, an obstacle, a red light, a toll collecting station, and other road events.

When recognizing the traveling lane, the recognition part 130 recognizes the position and the posture of the own vehicle M with respect to the traveling lane. The recognition part 130, for example, may also recognize, as the relative position and the posture of the vehicle M with respect to the traveling lane, the deviation of the own vehicle M with respect to the reference point of the own vehicle M from the lane center and the angle of the traveling direction of the vehicle M formed with respect to the line connecting the lane centers. Alternatively, the recognition part 130 may also recognize, as the relative position of the own vehicle M with respect to the traveling lane, the position of the reference point of the own vehicle M with respect to either side end (the road compartment line or the road boundary) of the traveling lane, etc.

The recognition part 130, for example, includes an overtaking vehicle recognition part 132 recognizing an another vehicle (hereinafter “overtaking vehicle”) trying to overtake the own vehicle. Here, overtaking means that a vehicle traveling in a lane changes to another lane and then moves relatively to the front side over another vehicle traveling ahead in the same lane, and then returns to the original lane (lane-changing). The specific process of the overtaking vehicle recognition part 132 will be described afterwards.

The recognition part 130 notifies the action plan generation part 140 with various recognition results relating to objects in the periphery of the own vehicle M. In the case where the own vehicle M is able to communicate with another vehicle through inter-vehicle communication, the recognition part 130 may also perform some or all of the recognition relating to objects in the periphery of the own vehicle M based on information received from other vehicles.

The action plan generation part 140 generates a target track along which the vehicle M will automatically travel (without depending on the operation of the driver) so that the own vehicle M generally travels on the recommended lane determined by the recommended lane determining part 61, so as to be able to cope with the situation in the periphery of the vehicle M. The target track, for example, includes a velocity component. For example, the target track is represented as points (track points) at which the own vehicle M should arrive and which are arranged one after another in order. The track point is a point at which the own vehicle M should arrive for each predetermined traveling distance (e.g., at the level of several meters (m)) in the road distance, and, different thereto, a target velocity and a target acceleration for each predetermined sampling time (e.g., at the level of some tenths of a second) are generated as a part of the target track. In addition, the track point may also be the position at which the own vehicle M should arrive at the sampling time for each sampling time. In such case, the information of the target velocity and the target acceleration are represented by the intervals of the track points.

The action plan generation part 140 may set an automatic driving event when the target track is generated. The automatic driving event includes a fixed velocity traveling event, a low velocity following traveling event, a lane changing event, a branch event, a joining event, a takeover event, etc. The action plan generation part 140 generates the target track in accordance with an activated event.

In addition, the action plan generation part 140 includes a velocity adjustment part 142 operating in the case where another vehicle is recognized as the overtaking vehicle by the recognition part 130. The specific process of the velocity adjustment part 142 will be described afterwards.

The second control part 160 controls the traveling driving force output part 200, the brake device 210, and the steering device 220, so that the own vehicle M passes through the target track generated by the action plan generation part 140 at the expected time.

Referring to FIG. 2 again, the second control part 160, for example, includes an acquisition part 162, a velocity control part 164, and a steering control part 166. The acquisition part 162 obtains the information of the target track (track points) generated by the action plan generation part 140 and stores the information in a memory (not shown). The velocity control part 164 controls the traveling driving force output device 200 or the brake device 210 based on the velocity component associated with the target track stored in the memory. The steering control part 166 controls the steering device 220 in accordance with the curvature degree of the target track stored in the memory. The processes of the velocity control part 164 and the steering control part 166 are realized by combining feed-forward control and feedback control, for example. As an example, the steering control part 166 combines and executes the feed-forward control in accordance with the curvature of the road ahead of the own vehicle M and the feedback control based on the deviation from the target track.

The traveling driving force output device 200 outputs a traveling driving force (torque) for traveling of the vehicle to a driving wheel. The traveling driving force output device 200, for example, includes a combination of an internal combustion mechanism, an electric motor, and a transmission, etc., and an electronic control unit (ECU) controlling the combination. The ECU controls the above configuration in accordance with the information input from the second control part 160 or the information input from the driving operator 80.

The brake device 210 includes for example, a brake caliper, a cylinder transmitting a hydraulic pressure to the brake caliper, an electric motor generating the hydraulic pressure in the cylinder, and a brake ECU. The brake ECU controls the electric motor in accordance with the information input from the second control part 160 or the information input from the driving operator 80, so as to output a brake torque in accordance with the brake operation to each wheel. The brake device 210 may also include, as a back-up, a mechanism which transmits a hydraulic pressure generated in accordance with an operation on a brake pedal included in the driving operator 80 to the cylinder via a master cylinder. It should be noted that the brake device 210 is not limited to the above configuration, but may also be an electronically controlled hydraulic pressure brake device which controls an actuator in accordance with the information input from the second control part 160 and transmits the hydraulic pressure of the master cylinder to the cylinder.

The steering device 220 includes, for example, a steering ECU and an electric motor. The electric motor, for example, applies a force to a rack and pinion mechanism to change the direction of a steering wheel. The steering ECU drives the electric motor to change the direction of the steering wheel in accordance with the information input from the second control part 160 or the information input from the driving operator 80.

[Regarding Control Corresponding to Overtaking Vehicle]

In the following, the control corresponding to the overtaking vehicle will be described. The following control is executed at the time of an event with a relatively high degree of control freedom, such as a fixed velocity driving event. In the case where a lane changing event or a joining event is executed, the following process also prioritizes the control for lane changing or joining.

The overtaking vehicle recognition part 132 recognizes, among the objects in the periphery of the own vehicle M, an another vehicle traveling in the same lane with the own vehicle M and performing a preparation operation for overtaking the own vehicle M behind the own vehicle M. For example, the overtaking vehicle recognition part 132 recognizes the another vehicle as the overtaking vehicle in the case where the another vehicle traveling behind the own vehicle M satisfies some or all of the following conditions as the preparation operation for overtaking the own vehicle M. It should be noted that the conditions below are merely provided as an example, and the condition at the time of determining whether a vehicle is the overtaking vehicle may also include other conditions.

(1) The another vehicle starts accelerating.

(2) The another vehicle starts moving laterally toward the overtaking lane side.

Here, “overtaking lane” refers to a lane in which the another vehicle travels at the time of overtaking the own vehicle M, and it does not matter whether such lane is a lane in the same direction as the lane in which the own vehicle M travels.

(3) The direction indicator of the own vehicle is blinking.

The velocity adjustment part 142 determines the traveling velocity of the own vehicle M based on the number of lanes of the road on which the own vehicle travels. More specifically, in the case where the overtaking vehicle is recognized, the velocity adjustment part 142 manages the another vehicle as the overtaking vehicle until a predetermined cancellation condition is satisfied thereafter, determines whether the own vehicle M should decelerate based on the state of the overtaking vehicle under management and the number of lanes of the road on which the own vehicle M travels, and instructs the second control part 160 to decelerate the own vehicle M in accordance with the determining result thereof. The cancellation condition may also be set based on any criteria capable of determining that it is no longer necessary to consider the state of the overtaking vehicle regarding the traveling of the own vehicle M. For example, the cancellation condition may also be a condition capable of determining that the overtaking of the overtaking vehicle over the own vehicle M has completed or has been canceled. In addition, for example, the cancellation condition may also be set as that the distance between the overtaking vehicle and the own vehicle M is equal to or greater than a predetermined distance.

Accordingly, in the embodiment, in addition to the function of controlling the traveling velocity of the own vehicle M in accordance with the automatic driving level, the action plane generation part 140 also has the function of adjusting the traveling velocity of the own vehicle M in the case where the overtaking vehicle is recognized. That is, with the action plan generation part 140 including the velocity adjustment part 142 in the automatic driving control device 100 of the embodiment, the temporary velocity control in the case where the overtaking vehicle is present is additionally realized in the conventional automatic driving control controlling the traveling velocity of the own vehicle M in accordance with the automatic driving level.

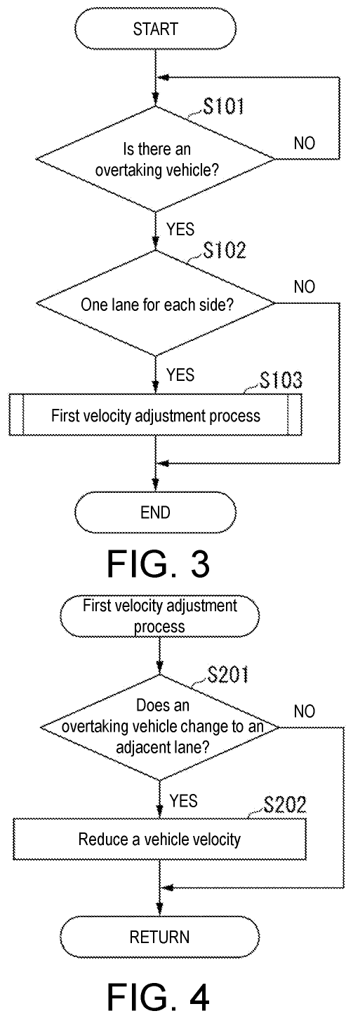

FIG. 3 is a flowchart illustrating a specific example of velocity adjustment of the own vehicle M in the first embodiment. Here, for the ease of description, it is assumed that the own vehicle M travels on a road with two lanes. In such case, firstly, the overtaking vehicle recognition part 132 tries to detect an overtaking vehicle (Step S101). Here, in the case of not detecting an overtaking vehicle, the overtaking vehicle recognition part 132 returns to the process of Step S101 and repetitively executes the process of detecting an overtaking vehicle.

Alternatively, in the case where an overtaking vehicle is detected in Step S101, the overtaking vehicle recognition part 132 determines whether the road on which the own vehicle M travels is a road with one lane for each side (Step S102). The road with one lane for each side is an example of a first type road of the disclosure, and is a road having one single lane for one traveling direction. In the case where the road on which the own vehicle M is currently traveling is a road with one lane for each side, that is, in the case where the adjacent lane of the own lane is an opposite direction lane, the velocity adjustment part 142 executes a first velocity adjustment process (Step S103).

Meanwhile, in Step S102, in the case where the road on which the own vehicle M is currently traveling is determined as not a road with one lane for each side, that is, the lane direction of the adjacent lane is in the same direction as the lane direction of the own lane, the velocity adjustment part 142 does not execute the first velocity adjustment process and ends the flowchart.

In the automatic driving control, by repetitively executing the process flow shown in FIG. 3 at a predetermined interval, in the case where there is an overtaking vehicle when the own vehicle M travels on a road with one lane for each side, the automatic driving control device 100 can repetitively execute the first velocity adjustment process. The flow of the first velocity adjustment process will be described in the following with reference to FIG. 4.

FIG. 4 is a flowchart illustrating a specific example of the first velocity adjustment process in the first embodiment. In the first velocity adjustment process, first of all, the velocity adjustment part 142 determines whether the lane changing of the overtaking vehicle to the adjacent lane is completed (Step S201). For example, the velocity adjustment part 142 may determine that the lane changing is completed in the case where the entire overtaking vehicle has entered the adjacent lane, and may also determine that the lane changing is completed in the case that all the wheels of the overtaking vehicle have entered the adjacent lane. Here, in the case where the lane changing of the overtaking vehicle to the adjacent lane is determined as completed, the velocity adjustment part 142 instructs the second control part 160 to decelerate the own vehicle M (Step S202) (first velocity adjustment). Alternatively, in the case where the lane changing of the overtaking vehicle to the adjacent lane is not determined as completed, the velocity adjustment part 142 ends the first velocity adjustment process without instructing the second control part 160 to decelerate the own vehicle M.

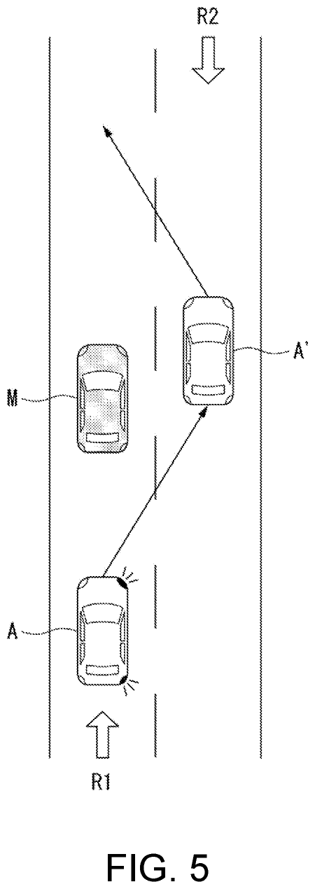

For example, the example of FIG. 5 shows the case where an adjacent lane R2 with respect to an own lane R1 in which the own vehicle M travels is an opposite direction lane of the own lane R1. In such case, the overtaking vehicle recognition part 132 recognizes, as an overtaking vehicle, another vehicle A which travels in the lane R1 same as the own vehicle M behind the own vehicle M and in which the direction indicator is blinking as the preparation operation for lane changing to an adjacent lane R2. In addition, in such case, since the adjacent lane R2 is an opposite direction lane of the own lane R1, the velocity adjustment part 142 decelerates the own vehicle M in accordance with the completion of the lane changing of the another vehicle A to the adjacent lane R2, such as the another vehicle A moving to a position A′.

While the case where the automatic driving control device 100 decelerates the own vehicle M after the completion of the lane changing of the overtaking vehicle is described herein, it is not always necessary that the own vehicle M is decelerated by the automatic driving control device 100 after the lane changing of the overtaking vehicle is completed. The automatic driving control device 100 may also decelerate the own vehicle M before the lane changing of the overtaking vehicle is completed as long as the deceleration of the own vehicle M does not cause any adverse effect to the traveling of other vehicles. For example, the velocity adjustment part 142 may also decelerate the own vehicle M at the timing when the overtaking vehicle enters the lane as the changing destination, and may also decelerate the own vehicle M at the timing when a specific portion of the vehicle body of the overtaking vehicle enters the lane as the changing destination. In other words, the velocity adjustment part 142 may decelerate the own vehicle M in the case where the overtaking vehicle performs lane changing.

In the case where there is an overtaking vehicle during traveling on a road with one lane for each side, the automatic driving control device 100 of the first embodiment so configured executes the first velocity adjustment which decelerates the own vehicle M in accordance with the completion of the lane changing of the overtaking vehicle to the adjacent lane. In addition, according to the first velocity adjustment, since the overtaking vehicle can quickly overtake the own vehicle M, in the case where the own vehicle M travels on a road with one lane for each side under automatic driving, the traveling safety in the case where an overtaking vehicle is approaching can be increased.

### Second Embodiment

The automatic driving control device 100 of the second embodiment differs from the automatic driving control device 100 of the first embodiment in that the automatic driving control device 100 of the second embodiment performs velocity adjustment in the case where the own vehicle M travels on a road with two lanes for each side in addition to the case where the own vehicle M travels on a road with one lane for each side. The road with two lanes for each side is an example of a second type road of the disclosure, and is a road having multiple lanes for one traveling direction. While the contents of the velocity adjustment executed by the velocity adjustment part 142 are partially different, the configuration of the automatic driving control device 100 of the second embodiment is the same as the automatic driving control device 100 of the first embodiment.

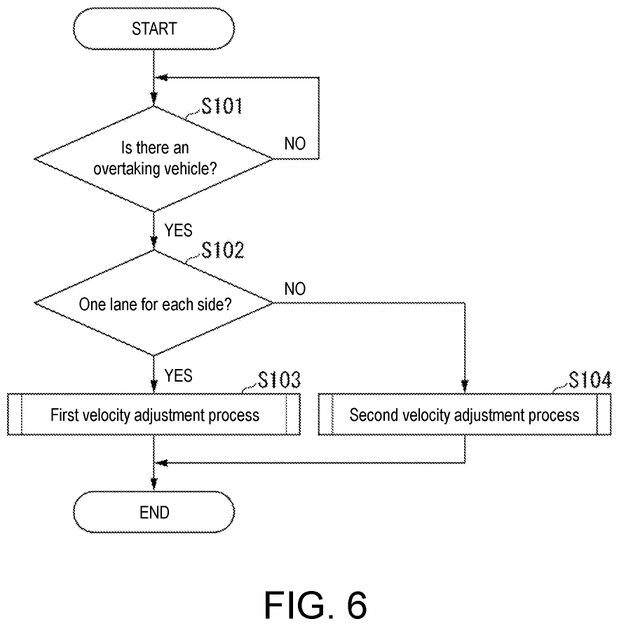

FIG. 6 is a diagram illustrating a specific example of velocity adjustment of the own vehicle M in the second embodiment. Here, for the ease of description, it is assumed that the own vehicle M travels on a road with one lane for each side or two lanes for each side. The flow of the process of the velocity adjustment (first velocity adjustment) when the own vehicle M travels on a road with one lane for each side is the same as that of the first embodiment. Therefore, regarding the first velocity adjustment process, reference symbols same as those of FIG. 3 are used, and the descriptions thereof will be omitted.

The velocity adjustment part 142 of the second embodiment differs from the velocity adjustment part 142 of the first embodiment in that the velocity adjustment part 142 of the second embodiment executes a second velocity adjustment process in the case where the own vehicle M travels on a road with two lanes for each side at the time when detecting an overtaking vehicle. Specifically, in Step S102, in the case where the road on which the own vehicle M travels is not a road with one lane for each side, that is, in the case of a road with two lanes for each side, the velocity adjustment part 142 executes the second velocity adjustment process (Step S104). In this case, in addition to decelerating the own vehicle M by the second velocity adjustment process, the velocity adjustment part 142 basically continues the automatic driving control based on a vehicle velocity (set velocity) in accordance with the automatic driving level and does not accelerate.

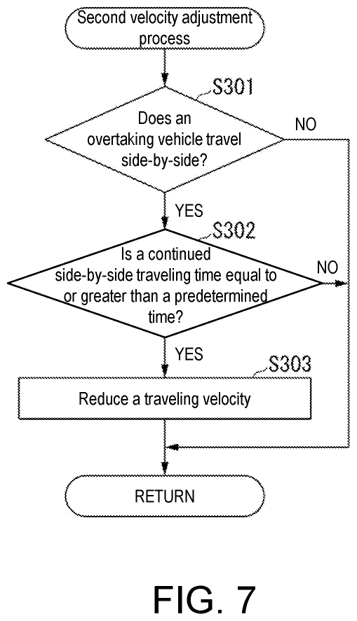

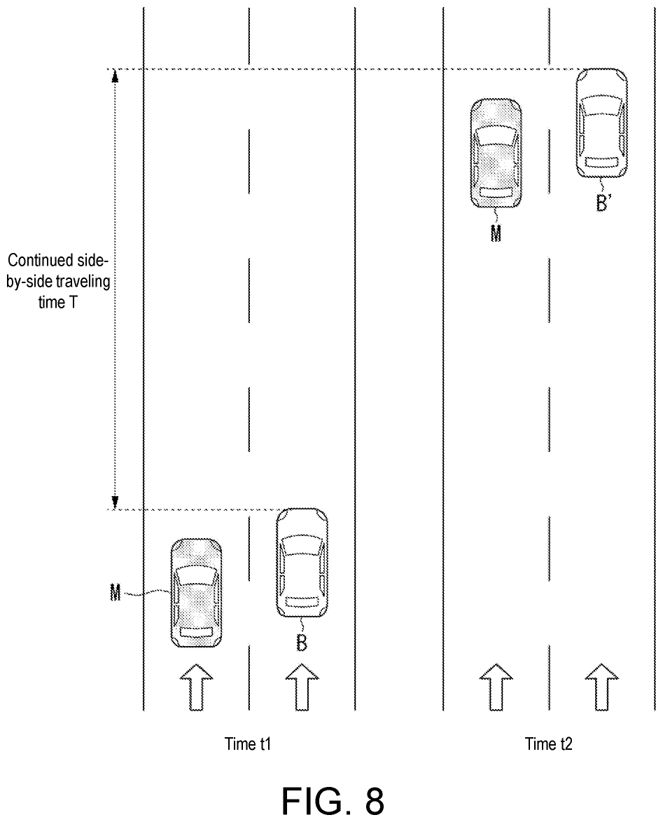

FIG. 7 is a flowchart illustrating a specific example of the second velocity adjustment process in the second embodiment. In the second velocity adjustment process, first of all, the velocity adjustment part 142 determines whether the overtaking vehicle travels side-by-side with the own vehicle M (Step S301). Here, in the case where the overtaking vehicle does not travel side-by-side with the own vehicle M, the velocity adjustment part 142 ends the second velocity adjustment process. Alternatively, in the case where the overtaking vehicle is determined as traveling side-by-side with the own vehicle M in Step S301, the velocity adjustment part 142 determines whether the time (referred to as “continued side-by-side traveling time” in the following) in which the overtaking vehicle travels side-by-side with the own vehicle M is equal to or longer than a predetermined time (Step S302).

For example, whether the overtaking vehicle travels side-by-side with the own vehicle can be determined based on the position information of the own vehicle M and the overtaking vehicle, and the continued side-by-side traveling time can be acquired by measuring the passing time since the own vehicle M and the overtaking vehicle are in the side-by-side traveling state. Here, the velocity adjustment part 142 may separately manage the continued side-by-side traveling time of the overtaking vehicle and the own vehicle as a part of the overtaking vehicle management.

In Step S302, in the case where the continued side-by-side traveling time of the overtaking vehicle is determined as less than the predetermined time, the velocity adjustment part 142 ends the second velocity adjustment process. Alternatively, in Step S302, in the case where the continued side-by-side traveling time of the overtaking vehicle is determined as equal to or longer than the predetermined time, the velocity adjustment part 142 instructs the second control part 160 to decelerate the own vehicle M (Step S303) (second velocity adjustment).

For example, FIG. 8 is a diagram illustrating a specific example of a situation in which the own vehicle M and the overtaking vehicle travel side-by-side for a predetermined time or more on a road with two lanes for each side. Specifically, FIG. 8 illustrates a state in which the side-by-side traveling of an overtaking vehicle B with the own vehicle M starts at a time t1 and the continued side-by-side traveling time with the own vehicle M reaches a predetermined threshold time T at a time t2. In this case, the velocity adjustment part 142 decelerates the own vehicle M at a timing when the overtaking vehicle B travels for the continued side-by-side traveling time from the time t1 to arrive at a position B′.

In the example of FIG. 7, as the condition of whether to decelerate the traveling velocity, whether the continued side-by-side traveling time is equal to or longer than the predetermined time is determined. However, in place thereof, the velocity adjustment part 142 may also be configured to decelerate the own vehicle M in the case where the side-by-side traveling between the own vehicle M and the overtaking vehicle continues for a predetermined distance or more.

In the case where side-by-side traveling with an overtaking vehicle occurs during traveling on a road with two lanes for each side, the automatic driving control device 100 of the second embodiment so configured executes the second velocity adjustment which decelerates the own vehicle M in accordance with the continued side-by-side traveling time with the overtaking vehicle reaching or passing the predetermined time. According to the second velocity adjustment, since the overtaking vehicle can quickly overtake the own vehicle M, in the case where the own vehicle M travels on a road with two lanes for each side under automatic driving, the traveling safety in the case where an overtaking vehicle is approaching can be increased.

In addition, the automatic driving control device 100 of the second embodiment does not determine an another vehicle which does not try to overtake the own vehicle M, such as an another vehicle which has been traveling on the adjacent lane and is approaching, as an overtaking vehicle and does not decelerate more than necessary. Therefore, according to the automatic driving control device 100 of the second embodiment, the traffic condition can be prevented from worsening due to excessive deceleration, and the interference on the traveling of the own vehicle M and the overtaking vehicle can also be reduced.

### Third Embodiment

The automatic driving control device 100 of the third embodiment differs from the automatic driving control device 100 of the second embodiment in that in the case where an another vehicle managed as an overtaking vehicle is side-by-side with the own vehicle M and stops temporarily, the automatic driving control device 100 of the third embodiment does not decelerate the traveling velocity when the vehicle resumes traveling. While the contents of the velocity adjustment executed by the velocity adjustment part 142 are partially different, the configuration of the automatic driving control device 100 of the third embodiment is the same as the automatic driving control device 100 of the first and second embodiments.

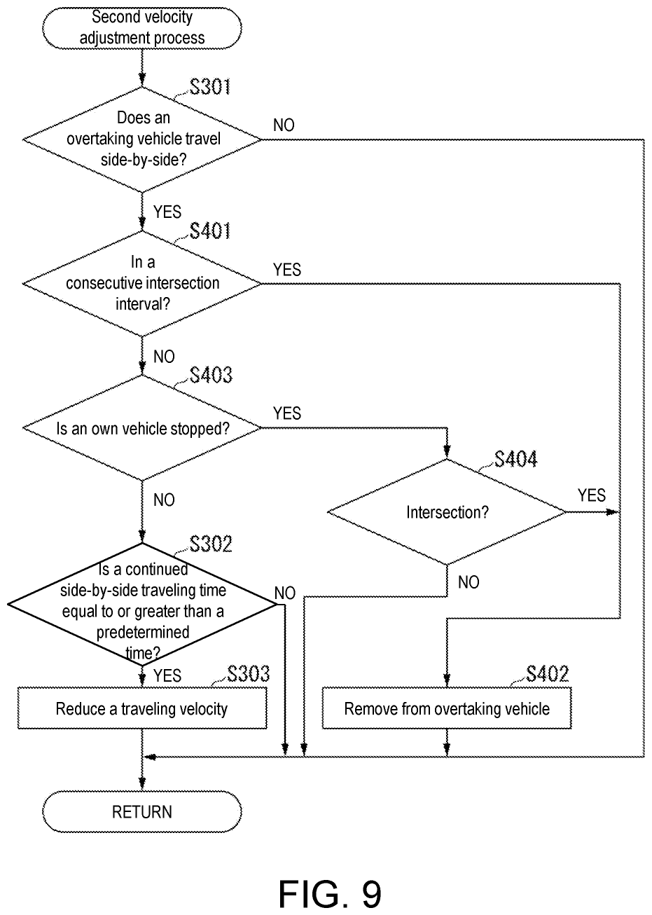

FIG. 9 is a flowchart illustrating a specific example of the second velocity adjustment process in the third embodiment. Here, for the ease of description, like the second embodiment, it is assumed that the own vehicle M travels on a road with one lane for each side or two lanes for each side. The flow of the process of the velocity adjustment (first velocity adjustment) when the own vehicle M travels on a road with one lane for each side is the same as that of the first embodiment. Therefore, regarding the first velocity adjustment process, reference symbols same as those of FIG. 3 are used, and the descriptions thereof will be omitted. In addition, in the flowchart, a part of the process of the velocity adjustment (second velocity adjustment) when the own vehicle M travels on a road with two lanes for each side is the same as that of the second embodiment. Therefore, regarding the process same as the second velocity adjustment process in the second embodiment, reference symbols same as those of FIG. 7 are used, and the descriptions thereof will be omitted.

In the second velocity adjustment process of the third embodiment, in the case where the overtaking vehicle is determined as traveling side-by-side with the own vehicle M, the velocity adjustment part 142 determines whether the current position of the own vehicle M is in a consecutive stop line interval (Step S401). Here, the consecutive stop line interval is an interval in which stop lines are consecutive at an interval of a predetermined distance or less. In the following, intersections are taken as an example of the stop lines, and an interval in which the intersections are consecutive at an interval of a predetermined distance or less (referred to as “intersection consecutive interval”) is described as an example of the consecutive stop line interval. For example, in such case, the overtaking vehicle recognition part 132 recognizes the intersections present within a predetermined interval ahead or behind in the traveling direction of the own vehicle M based on the map information, the velocity adjustment part 142 specifies the range of the consecutive intersection interval by determining whether the distance between the respective intersections is less than or equal to the predetermined distance and the intersection are consecutive. The velocity adjustment part 142 can determine whether the vehicle M is located in the range of the intersection consecutive interval based on the specified intersection consecutive interval and the position information of the own vehicle M.

In Step S401, in the case where the own vehicle M is determined as being located in the consecutive intersection interval, the velocity adjustment part 142 removes an another vehicle which stops side-by-side with the own vehicle M from the overtaking vehicle management (Step S402) and then ends the second velocity adjustment process. Instead of removing the another vehicle from the overtaking vehicle management, the velocity adjustment part 142 may also perform management so that the another vehicle is not regarded as an overtaking vehicle until the another vehicle satisfies a predetermined condition. In such case, the predetermined condition may be that a predetermined time has passed since the another vehicle resumes traveling and may also be that the another vehicle exits the state of traveling side-by-side with the own vehicle M.

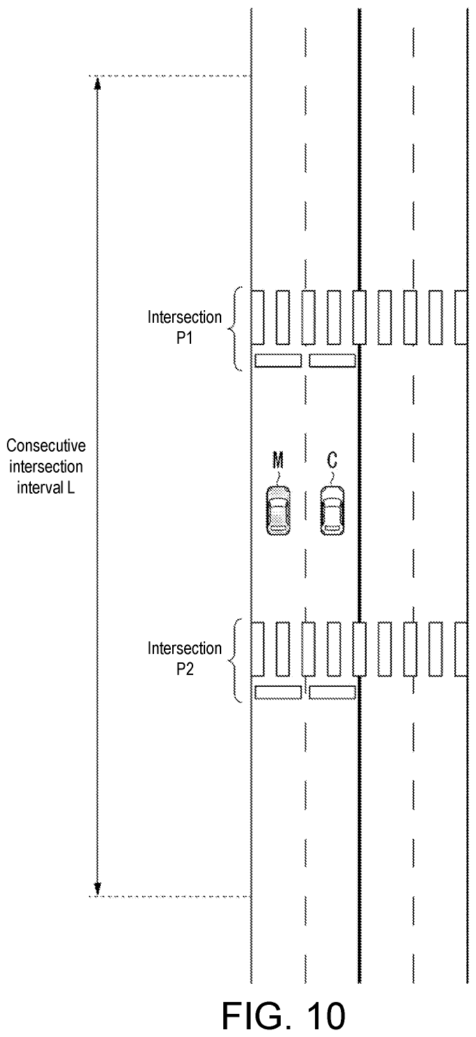

For example, FIG. 10 is a view illustrating a specific example of a situation in which the own vehicle M and the overtaking vehicle travel within a consecutive intersection interval on a road with two lanes for each side. The example of FIG. 10 illustrates a consecutive intersection interval with two consecutive intersections P1 and P2. The consecutive intersection interval may be set as long as the interval from the initial intersection to the last intersection is included. For example, the consecutive intersection interval may be set as an interval from the initial intersection to the last intersection, and may also be set as an interval from a place before the initial intersection by a predetermined distance to a place advanced from the last intersection by a predetermined distance. In such case, in the situation in which the own vehicle M travels within an intersection consecutive interval L, the velocity adjustment part 142 removes another vehicle C traveling side-by-side from the overtaking vehicle management. Accordingly, even when the overtaking vehicle C travels side-by-side with the own vehicle M in the consecutive intersection interval, the velocity adjustment part 142 is able to not decelerate the own vehicle M.

Alternatively, in the case where the own vehicle M is determined as not located in the consecutive intersection interval in Step S401, the velocity adjustment part 142 determines whether the own vehicle M is stopped (Step S403). Here, in the case where the own vehicle M is determined as not stopped, the velocity adjustment part 142 proceeds to the process of Step S302.

Alternatively, in the case where the own vehicle M is determined as stopped in Step S403, the velocity adjustment part 142 determines whether the own vehicle M stops at an intersection (Step S404). In the case where the own vehicle M is determined as stopped at a place other than an intersection, the velocity adjustment part 142 ends the second velocity adjustment process. Alternatively, in the case where the own vehicle M is determined as stopped at an intersection in Step S404, the velocity adjustment part 142 proceeds to Step S402, removes an another vehicle which stops side-by-side with the own vehicle M from the overtaking vehicle management and then ends the second velocity adjustment process.

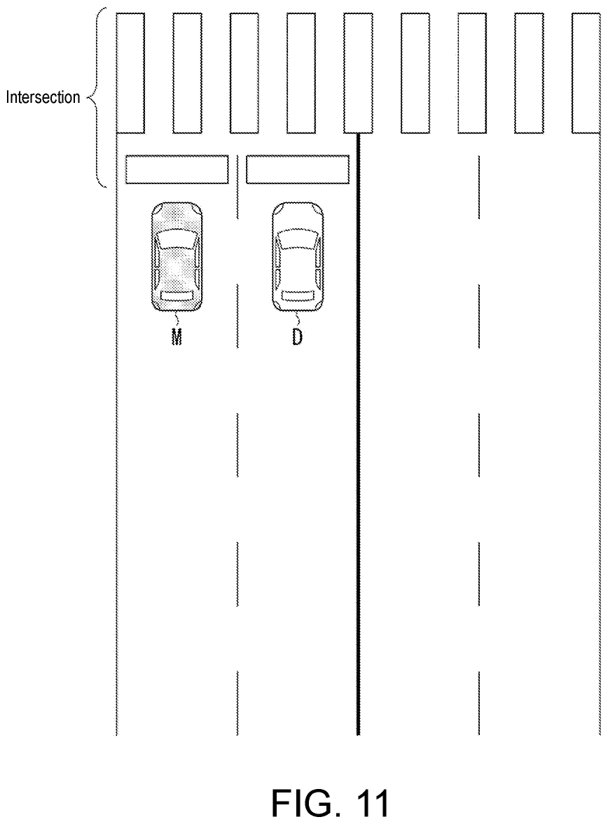

For example, FIG. 11 is a diagram illustrating a specific example of a situation in which the own vehicle M and an overtaking vehicle D stop side-by-side at an intersection. In such case, the velocity adjustment part 142 removes the another vehicle D from the overtaking vehicle management at the time when the another vehicle D as an overtaking vehicle stops side-by-side with the own vehicle M at the intersection. Accordingly, even if the overtaking vehicle D temporarily stops at the intersection and then travels side-by-side with the own vehicle M within a predetermined period after resuming traveling, the velocity adjustment part 142 is able to not decelerate the own vehicle M. The predetermined period after the another vehicle D resumes traveling is a period until the vehicle D is again managed as an overtaking vehicle.

In this case as well, like the case of the consecutive intersection interval, instead of removing the another vehicle D from overtaking vehicle management, the velocity adjustment part 142 may also perform management so that the another vehicle D is not regarded as an overtaking vehicle until the another vehicle D satisfies a predetermined condition. In such case, the predetermined condition may be that a predetermined time has passed since the another vehicle D resumes traveling and may also be that the another vehicle D exits the state of traveling side-by-side with the own vehicle M. In addition, in such case, the predetermined period after resuming traveling may be a period after a predetermined time has passed since the vehicle D resumes traveling or a period since the another vehicle D resumes traveling until the vehicle D exits the state of traveling side-by-side with the own vehicle.

In the case where the own vehicle M traveling on a road with two lanes for each side stops side-by-side with an overtaking vehicle at an intersection, the automatic driving control device 100 of the third embodiment so configured can cause the own vehicle M to travel without executing the second velocity adjustment in a predetermined time after the own vehicle M resumes traveling. In addition, in the case where the own vehicle M traveling on a road with two lanes for each side travels side-by-side with an overtaking vehicle in the consecutive intersection interval, the automatic driving control device 100 of the third embodiment can cause the own vehicle to travel without executing the second velocity adjustment. Moreover, according to such velocity adjustment, since the own vehicle M can quickly exit an intersection without decelerating in the case of traveling side-by-side with the overtaking vehicle, when the own vehicle M travels on a road with two lanes for each side by automatic driving, the traveling safety in the case where an overtaking vehicle is approaching can be increased.

### MODIFIED EXAMPLE

In the first to third embodiments, the ECU 20 may be configured as one electronic control unit, and may also be configured as being distributed into multiple electronic control units.

In the first to third embodiments, the overtaking vehicle recognition part 132 may also include, in the condition of determining a following vehicle as an overtaking vehicle, that the inter-vehicle distance between the own vehicle M and the following vehicle is equal to or less than a predetermined distance. In addition, the overtaking vehicle recognition part 132 may also include, in the condition of determining that the following vehicle as an overtaking vehicle, that the following vehicle accelerates.

In the first to third embodiments, the velocity adjustment part 142 may be configured to decelerate the own vehicle M since the overtaking vehicle entirely enters the overtaking lane, and may also be configured to decelerate the own vehicle at the timing when a portion of the overtaking vehicle enters the overtaking lane.

In the first embodiment, while the case where the automatic driving control device 100 determines the traveling velocity of the own vehicle M based on the number of lanes of the road on which the own vehicle M travels when an overtaking vehicle is recognized is described, the velocity of the own vehicle M may also be adjusted without considering the number of lanes of the road on which the own vehicle M travels. For example, in this case, the automatic driving control part 100 may also be configured as including: a recognition part which recognizes an overtaking vehicle presumed to overtake an own vehicle from the rear of the own vehicle in an own lane in which the own vehicle travels; and a driving control part, automatically controlling at least acceleration and deceleration of the own vehicle, and decelerating the own vehicle in the case where the overtaking vehicle is recognized, and lane changing of the recognized overtaking vehicle from the own lane to an adjacent lane is completed.

In the second embodiment, while the case where the automatic driving control device 100 decelerates the own vehicle M based on the continued side-by-side traveling time between the overtaking vehicle and the own vehicle when the overtaking vehicle is recognized is described, such velocity adjustment of the own vehicle M may also be executed based on the continued side-by-side traveling time with another vehicle not an overtaking vehicle. For example, in such case, the automatic driving control device 100 may also be configured as including: a recognition part recognizing a side-by-side traveling vehicle which is another vehicle traveling side-by-side with an own vehicle; and a driving control part, automatically controlling at least acceleration and deceleration of the own vehicle, and decelerating the own vehicle in the case where a side-by-side traveling state between the own vehicle and the side-by-side traveling vehicle continues for a predetermined time or more. The vehicle control part does not decelerate the own vehicle in accordance with the side-by-side traveling state in the case where the own vehicle travels side-by-side with the side-by-side traveling vehicle in front of an intersection. In such case, the driving control part decelerates the own vehicle in the case where the side-by-side traveling state between the own vehicle and the side-by-side traveling vehicle continues for the predetermined time or more, and does not decelerate the own vehicle in accordance with the side-by-side traveling state in the case where the own vehicle travels side-by-side with the side-by-side traveling vehicle in front of the intersection.

The velocity adjustment of the own vehicle M in the first to third embodiments may also be applied in adaptive cruise control (ACC), etc., which is not automatic driving.

[Hardware Configuration]

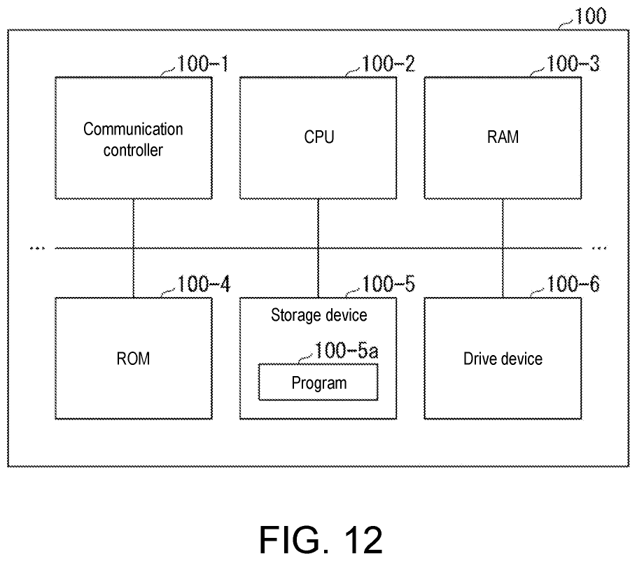

FIG. 12 is a diagram illustrating a specific example of a hardware configuration of the automatic driving control device 100 of the embodiment. As shown in the figure, the automatic driving control device 100 is in a configuration in which a communication controller 100-1, a CPU 100-2, a random access memory (RAM) 100-3 used as a working memory, a read only memory (ROM) 100-4 storing a boot program, a storage device 100-5 such as a flash memory or a hard disk drive (HDD), and a drive device 100-6, etc., are connected with each other through an internal bus or a designated communication line. The communication controller 100-1 performs communication with forming elements other than the automatic driving control device 100. The storage device 100-5 stores a program 100-5a executed by the CPU 100-2. The program is expanded in the RAM 100-3 by a direct memory access (DMA) controller (not shown) and executed by the CPU 100-2. Accordingly, some or all of the first control part 120 and the second control part 160 are realized.

The embodiment described above can be represented as follows.

A vehicle control device includes: a recognition part recognizing a side-by-side traveling vehicle which is another vehicle traveling side-by-side with an own vehicle; and

a driving control part, automatically controlling at least acceleration and deceleration of the own vehicle, and decelerating the own vehicle in the case where a side-by-side traveling state between the own vehicle and the side-by-side traveling vehicle continues for a predetermined time or more.

The vehicle control part does not decelerate the own vehicle in accordance with the side-by-side traveling state in the case where the own vehicle travels side-by-side with the side-by-side traveling vehicle in front of an intersection.

Conventionally, in the case where a side-by-side traveling vehicle is recognized, since the own vehicle accelerates to ensure a distance with the side-by-side traveling vehicle, it is possible that the traveling safety is not always sufficient at the time of traveling in the vicinity of an intersection. Comparatively, according to the vehicle control device so configured, since the own vehicle can ensure a distance with the side-by-side traveling vehicle by decelerating except for the case of an intersection, and can quickly exit an intersection by not decelerating at the intersection, the safety at the time of traveling in the vicinity of the intersection can be increased.

The embodiment described above can be represented as follows.

A vehicle control device includes: a recognition part, recognizing an overtaking vehicle presumed to overtake an own vehicle from rear of the own vehicle in an own lane in which the own vehicle travels; and

a driving control part, automatically controlling at least acceleration and deceleration of the own vehicle, and decelerating the own vehicle in the case where the overtaking vehicle is recognized, and lane changing of the recognized overtaking vehicle from the own lane to an adjacent lane is completed.

Conventionally, in the case where a side-by-side traveling vehicle is recognized, since the own vehicle accelerates to ensure a distance with the side-by-side traveling vehicle, it is possible that the traveling safety is not always sufficient at the time when there is an overtaking vehicle. Comparatively, according to the vehicle control device so configured, since the own vehicle can be quickly overtaken by the overtaking vehicle, the side-by-side traveling state with the overtaking vehicle can be minimized to further ensure the traveling safety.

The embodiment described above can be represented as follows.

A vehicle control device includes: a storage device storing a program; and

a hardware processor.

By executing the program stored in the storage device by the hardware processor, the vehicle control device is configured as including:

a recognition part, recognizing an overtaking vehicle presumed to overtake an own vehicle from rear of the own vehicle in an own lane in which the own vehicle travels; and

a driving control part, automatically controlling at least acceleration and deceleration of the own vehicle, and, in a case where the overtaking vehicle is recognized, determining a traveling velocity of the own vehicle based on a number of lanes of a road on which the own vehicle travels.

Although the embodiments for carrying out the disclosure have been described above with the embodiments, the disclosure is not limited to these embodiments, and various modifications and substitutions can be added without departing from the gist of the disclosure.

What is claimed is:

1. A vehicle control device, comprising:
a recognition part, recognizing an overtaking vehicle presumed to overtake an own vehicle from rear of the own vehicle in an own lane in which the own vehicle travels; and
a driving control part, automatically controlling at least acceleration and deceleration of the own vehicle, and, in a case where the overtaking vehicle is recognized, determining a traveling velocity of the own vehicle based on a number of lanes or a road type of a road on which the own vehicle travels.

2. The vehicle control device as claimed in claim 1, wherein in a case where the overtaking vehicle is recognized and the own vehicle travels on a first type road having a single lane for a traveling direction, when the recognized overtaking vehicle performs lane changing from the own lane to an adjacent lane, the driving control part decelerates the own vehicle.

3. The vehicle control device as claimed in claim 1, wherein in a case where the overtaking vehicle is recognized and the own vehicle travels on a second type road having a plurality of lanes for a traveling direction, the driving control part does not decelerate the own vehicle in accordance with an operation of the overtaking vehicle and maintains the traveling velocity of the own vehicle at a set velocity.

4. The vehicle control device as claimed in claim 3, wherein in a case where the overtaking vehicle is recognized, the own vehicle travels on the second type road, and a side-by-side traveling state between the overtaking vehicle and the own vehicle continues for a predetermined time or more, or the overtaking vehicle and the own vehicle travel side-by-side for a predetermined distance or more, the driving control part decelerates the own vehicle.

5. The vehicle control device as claimed in claim 4, wherein in a case where the own vehicle travels on the second type road and stops side-by-side with the overtaking vehicle at a stop line, within a predetermined period after the own vehicle resumes traveling, the driving control part does not decelerate the own vehicle in accordance with the side-by-side traveling state.

6. The vehicle control device as claimed in claim 4, wherein in a case where the own vehicle travels on the second type road and travels in a region in which stop lines are consecutive at an interval of a predetermined distance or less, the driving control part does not decelerate the own vehicle in accordance with the side-by-side traveling state.

7. A vehicle control method, comprising:
by a computer,
recognizing an overtaking vehicle presumed to overtake an own vehicle from rear of the own vehicle in an own lane in which the own vehicle travels; and
at a time when at least acceleration and deceleration of the own vehicle are under automatic control, in a case where the overtaking vehicle is recognized, determining a traveling velocity of the own vehicle based on a number of lanes or a road type of a road on which the own vehicle travels.

8. A non-transitory computer readable storage medium, storing a program causing a computer to:
recognize an overtaking vehicle presumed to overtake an own vehicle from rear of the own vehicle in an own lane in which the own vehicle travels; and
at a time when at least acceleration and deceleration of the own vehicle are under automatic control, in a case where the overtaking vehicle is recognized, determine a traveling velocity of the own vehicle based on a number of lanes or a road type of a road on which the own vehicle travels.

9. The vehicle control device as claimed in claim 2, wherein in a case where the overtaking vehicle is recognized and the own vehicle travels on a second type road having a plurality of lanes for a traveling direction, the driving control part does not decelerate the own vehicle in accordance with an operation of the overtaking vehicle and maintains the traveling velocity of the own vehicle at a set velocity.

10. The vehicle control device as claimed in claim 5, wherein in a case where the own vehicle travels on the second type road and travels in a region in which stop lines are consecutive at an interval of a predetermined distance or less, the driving control part does not decelerate the own vehicle in accordance with the side-by-side traveling state.
